(19) United States
(12) Patent Application Publication
(10) Pub. No.: US 2016/0059679 A1
(43) Pub. Date: Mar. 3, 2016

(54) ELECTRIC SWING DOOR AND OPERATING METHOD THEREOF

(71) Applicant: Hyundai Motor Company, Seoul (KR)

(72) Inventor: Seung Young Park, Jeonju-si (KR)

(73) Assignee: Hyundai Motor Company, Seoul (KR)

(21) Appl. No.: 14/566,258

(22) Filed: Dec. 10, 2014

(30) Foreign Application Priority Data
Sep. 1, 2014 (KR) 10-2014-0115589

(51) Int. Cl. B60J 5/04; B60Q 5/00; E05F 15/60

(52) U.S. Cl. CPC B60J 5/0497; B60J 5/047; B60J 5/0486; E05F 15/60; B60Q 5/005; B60Y 2200/143

(57) ABSTRACT

An electrical swing door may include a main arm configured to be pivotably disposed on a vehicle body and have a door opening or closing a boarding gate attached thereto, a door opening/closing motor configured to apply rotational force to the main arm and to be provided to the vehicle body to adjust the opening/closing of the door, and a lock releasing motor configured to release a latch fixing the door to the boarding gate.

### CROSS-REFERENCE TO RELATED APPLICATION

The present application claims priority to Korean Patent Application No. 10-2014-0115589, filed Sep. 1, 2014, the entire contents of which is incorporated herein for all purposes by this reference.

### BACKGROUND OF THE INVENTION

1. Field of the Invention

The present invention relates to an electrical swing door and an operation method thereof, and more particularly, to an electrical swing door improving quality of a swing door provided in a vehicle, and an operation method thereof.

2. Description of Related Art

In general, doors of a bus are placed at a front or a center of a vehicle body and are classified into a folding door and a swing door according to an open/close way, in which the folding door refers to a door partitioned into two sections which are overlapped with each other when the door is opened and are unfolded when the door is closed, thereby opening or closing the door, and the swing door refers to a door in which as arm formed to be bent is rotated at a predetermined angle, the door fixed in the arm is opened or closed while being rotated.

Particularly, a swing door according to the related art includes a motor provided in the vehicle body, an arm connected to the motor, a door fixed in the arm, a door controller controlling the motor, a latch fixing the door to the vehicle body, and a cable connected to a rack provided in the door controller to operate the latch according to a rotation of the rack.

The door is fixed to the vehicle body by the latch and the latch is released by the cable. However, since the cable has a large volume and a long length, it is complex to install the cable and there is no choice but to occur a bending of the cable. In addition, as a sheath covering the cable is worn down, operation defect may occur and as the operations are repeated, tension is changed, thereby easily degrading quality.

The motor used in the swing door according to the related art was operated to accelerate the swing door in order to apply large moment to the swing door upon opening or closing the swing door. As a result, since a closing sound of the swing door is loud, it has created a threatening atmosphere for passengers, and when an object got caught in the swing door, there was large possibility that the object will be damaged.

In addition, the door controller provided in the swing door according to the related art, which has a relay 3-stage controlling scheme, causes the swing door to be vibrated when the swing door is operated on an inclined place.

In addition, in the swing door according to the related art, when a door operation lever of a driver seat is manipulated, a driver has to continuously hold the operation lever until the opening/closing of the swing door is completed.

In addition, in the swing door according to the related art, there was high possibility of over-generating and discharging a dark current. Consequently, it was difficult to apply a wireless opening/closing apparatus and a door operation switch of one-touch type.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an electrical swing door improving quality of the swing door by providing a motor operating a latch to the swing door, and an operation method thereof.

According to various aspects of the present invention, an electrical swing door may include a main arm configured to be pivotably disposed on a vehicle body and have a door opening or closing a boarding gate attached thereto, a door opening/closing motor configured to apply rotational force to the main arm and to be provided to the vehicle body to adjust the opening/closing of the door, and a lock releasing motor configured to release a latch fixing the door to the boarding gate.

The lock releasing motor may include a bracket fixed to the door, a motor mounted on the bracket, a linkage connected to the latch through a center link provided in the door, and a wire connected to a door controller controlling the door opening/closing motor and the lock releasing motor.

The electrical swing door according may further include a door controller controlling the door opening/closing motor and the lock releasing motor, in which the door controller may include a release controlling device configured to control the lock releasing motor, a speed controlling device configured to control the door opening/closing motor, a safety device controlling apparatus configured to receive a signal of a photo sensor provided in the boarding gate, and a switching unit configured to receive an opening/closing signal of the door.

The release controlling device, the speed controlling device, the safety device controlling apparatus, and the switching unit may be formed on a single board.

The switching unit may include a door opening completion switch configured to be closed upon an opening completion of the door and opened upon a closing completion of the door, a door closing completion switch configured to be closed upon the closing completion of the door and opened upon the opening completion of the door, and an operation signal switch configured to be operated by receiving the opening/closing signal of the door which is generated from a one-touch switch configured to be provided to a driver seat of a vehicle.

The door controller may include a constant-voltage power supply switching regulator configured to convert power applied to the door controller, and a storage module configured to store a power down program stopping the door controller.

The boarding gate may include a buzzer making a sound at a time of the opening/closing of the door.

The door opening/closing motor may be attached to the door controller and the door opening/closing motor may include a link member connected to the main arm.

According to various aspects of the present invention, an opening method of an electrical swing door may include a door state checking step of checking a state of a door attached to a main arm pivotably disposed on a vehicle body, a latch releasing step of releasing a latch fixing the door to a boarding gate by operating a lock releasing motor controlled by a door controller provided in a vehicle and provided in the door by manipulating a one-touch switch configured to be disposed in a driver seat of the vehicle in which the boarding gate is formed in a state in which the door closes the boarding gate, and an opening step of opening the boarding gate by operating a door opening/closing motor connected to the main arm to rotate the main arm based on a center axis of the main arm in a length direction thereof and separating the door from the boarding gate.

The latch releasing step may include a step of checking whether or not a switch fails, in which a chattering state of one-touch switch is checked, a switch manipulating step of checking a manipulation of the one-touch switch, a notification step of making a sound by a buzzer provided in the boarding gate, and a releasing step of operating the lock releasing motor.

The opening step may be stopped in the case in which the one-touch switch is again manipulated, it is checked that the door is fully opened, or the door opening/closing motor is overloaded.

In the opening step, a rotation speed of the door opening/closing motor may be controlled by a speed controlling device provided in the door controller, the speed controlling device may control the number of revolutions of the door opening/closing motor in pulse width modulation (PWM) depending on a position of a door close completion switch provided in the door controller and may control a number of revolutions of the door opening/closing motor in decelerated PWM depending on a position of the door.

According to various aspects of the present invention, a closing method of an electrical swing door may include a door state checking step of checking a state of a door attached to a main arm pivotably disposed on a vehicle body, a closing initial step of making a sound by a buzzer controlled by a door controller provided in a vehicle and provided in a boarding gate by manipulating a one-touch switch configured to be disposed in a driver seat of the vehicle in which the boarding gate is formed in a state in which the door opens the boarding gate, and a closing step of closing the boarding gate by operating a door opening/closing motor connected to the main arm to rotate the main arm based on a center axis of the main arm in a length direction thereof and matching the door with the boarding gate.

The closing step may be stopped in the case in which the one-touch switch is again manipulated, it is checked that the door is fully closed, or the door opening/closing motor is overloaded.

The closing step may include an operation stopping step of stopping an operation of the door opening/closing motor when a photo sensor provided in the boarding gate senses an object in a course of closing the door, and a reverse operating step of reversely rotating the door opening/closing motor when the object gets caught between the door and the boarding gate in the course of closing the door to thereby separate the door from the boarding gate.

In the closing step, a rotation speed of the door opening/closing motor may be controlled by a speed controlling device provided in the door controller, and the speed controlling device may control the number of revolutions of the door opening/closing motor in slow start PWM so that the rotation speed of the door opening/closing motor is minimized at the time of starting the operation of the door opening/closing motor, and controls the number of revolutions of the door opening/closing motor in decelerated PWM depending on a position of the door.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of an exemplary electrical swing door according to the present invention.

FIG. 2 is a perspective view of a lock releasing motor provided in the exemplary electrical swing door of FIG. 1.

FIG. 3 is a front view and a plan view of the lock releasing motor of FIG. 2.

FIG. 4 is a view illustrating a case in which the lock releasing motor of FIG. 2 is mounted.

FIG. 5 is a photograph of a door controller provided in the exemplary electrical swing door of FIG. 1.

FIG. 6 is a logic block diagram of the door controller of FIG. 5.

FIG. 7 is a perspective view of a housing in which the door controller of FIG. 5 is embedded.

FIG. 8 is a perspective view of a door opening/closing motor and a door controller provided in the exemplary electrical swing door of FIG. 1.

FIG. 9 is a flowchart of an opening method of the exemplary electrical swing door according to the present invention.

FIG. 10 is a flowchart of a closing method of the exemplary electrical swing door according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

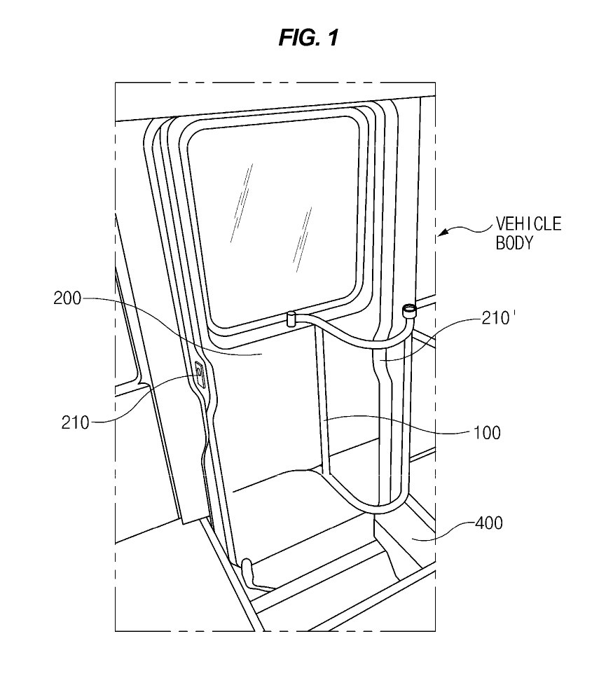

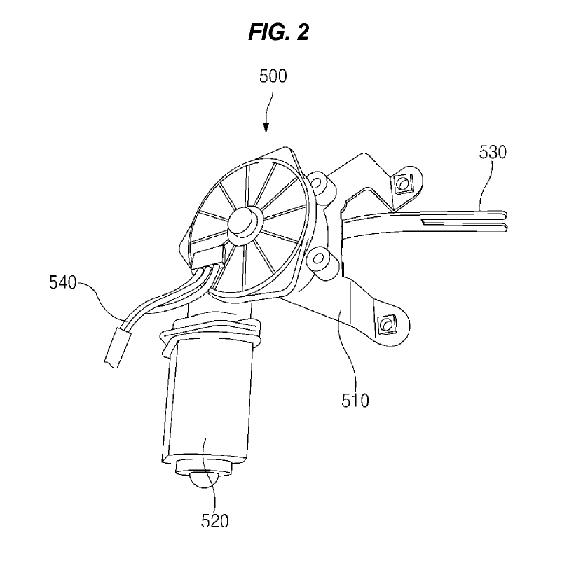

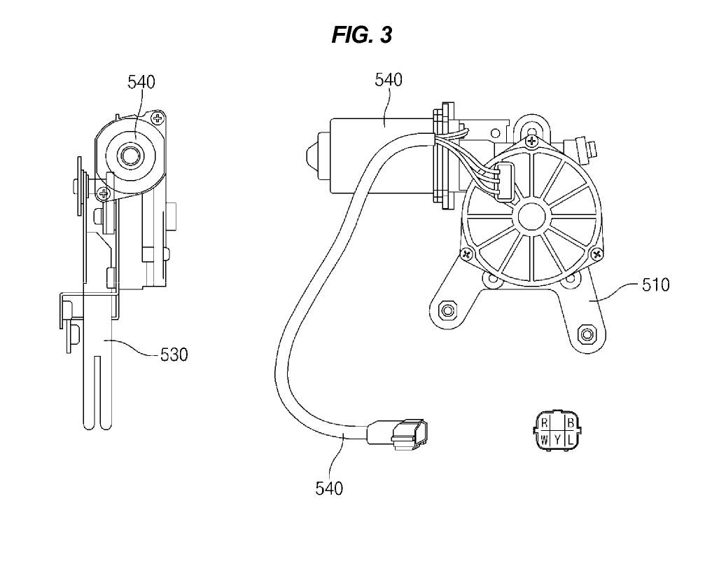

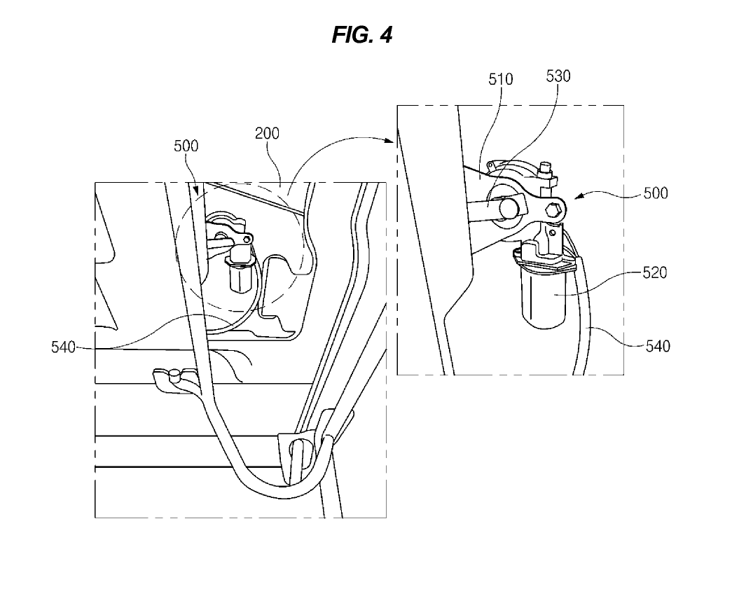

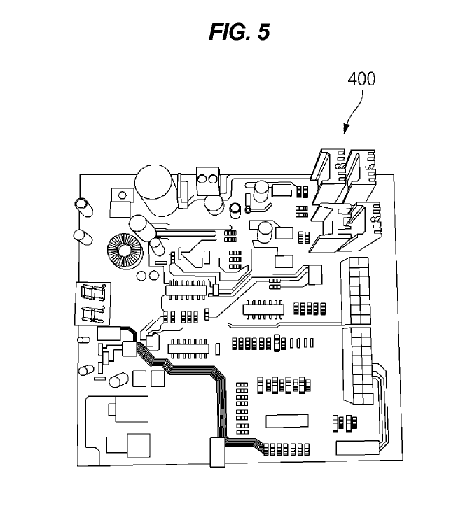

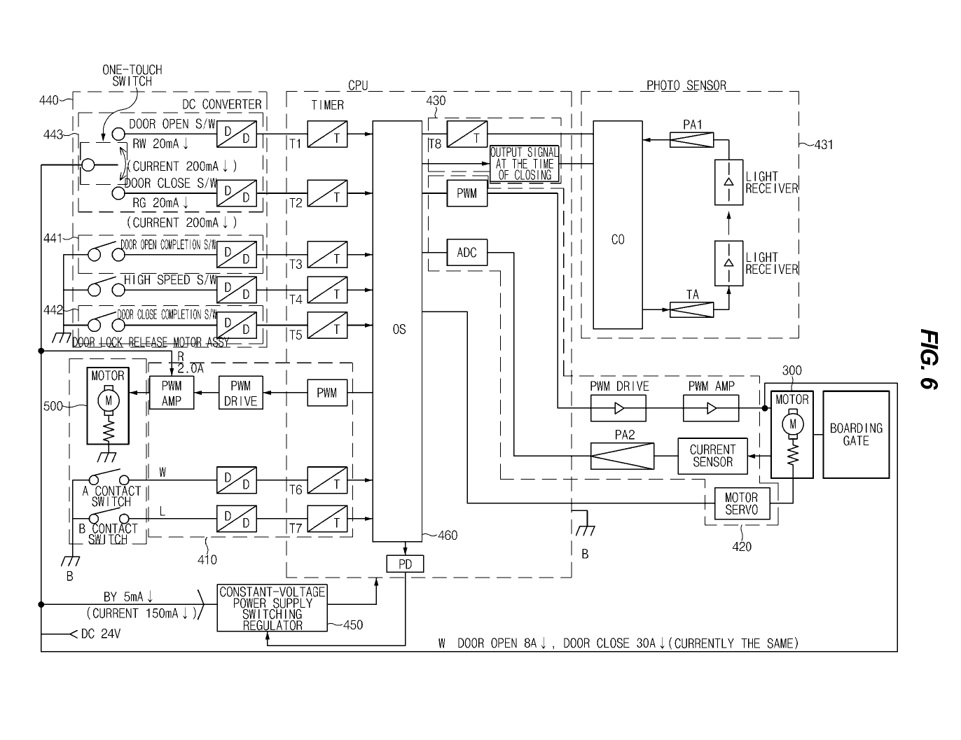

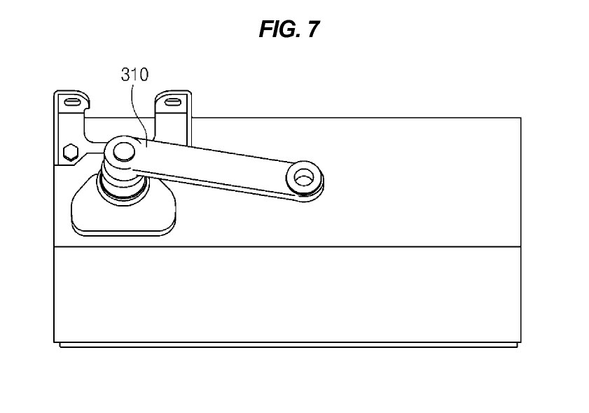

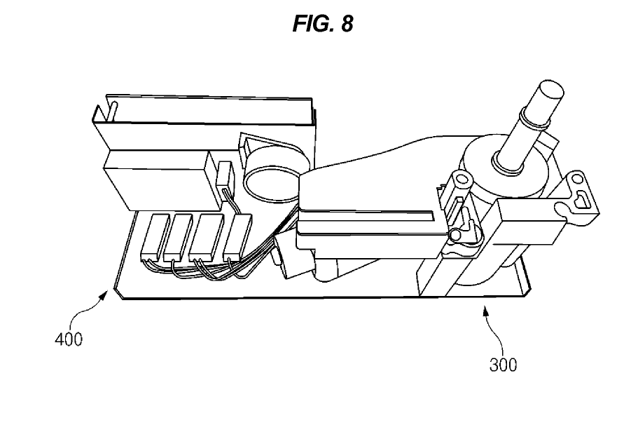

As illustrated in FIG. 1, FIG. 2, FIG. 3, FIG. 4, FIG. 5, FIG. 6, FIG. 7, and FIG. 8, an electrical swing door according to various embodiments of the present invention includes a main arm 100 pivotably disposed on a vehicle body and having a door opening or closing a boarding gate attached thereto, a door opening/closing motor 300 applying rotational force to the main arm 100 and provided to the vehicle body to adjust an opening/closing of a door 200, and a lock releasing motor 500 releasing a latch 210 fixing the door 200 to the boarding gate. In addition, the electrical swing door further includes a door controller 400 controlling the door opening/closing motor 300 and the lock releasing motor 500.

As illustrated in FIG. 1, the latch 210 according to various embodiments of the present invention is each mounted on both ends in a width direction of the door 200, that is, a total of two latches 210 and 210′ are mounted. The boarding gate includes a buzzer making a sound when the door 200 is opened or closed. The door opening/closing motor 300 is attached to one side of the door controller. The door opening/closing motor 300 includes a link member 310 connected to the main arm 100.

The lock releasing motor 500 includes a bracket 510 fixed to the door 200, a motor 520 mounted on the bracket 510, a linkage 530 connected to the latch 210 through a center link provided in the door 200, and a wire 540 connected to the door controller 400.

The lock releasing motor 500 releases the latch 210 when an electrical signal is applied thereto from the door controller 400. A position of the linkage 530 is changed by the rotational force of the motor 520 and as the position of linkage 530 is changed, the center link is operated, thereby releasing the latch 210.

Since the latch 210 is released by the lock releasing motor 500, a quality degradation problem of the swing door that was generated by using a conventional cable is prevented.

The door controller 400 includes a release controlling unit 410 controlling the lock releasing motor 500, a speed controlling unit 420 controlling the door opening/closing motor 300, a safety device controlling unit 430 receiving a signal of a photo sensor 431 provided in the boarding gate, and a switching unit 440 receiving an opening/closing signal of the door 200.

According to various embodiments of the present invention, the release controlling unit 410, the speed controlling unit 420, the safety device controlling unit 430, and the switching unit 440 are formed on a single board, such that a volume of the door controller 400 is minimized and a layout thereof is simplified.

The switching unit 440 includes a door opening completion switch 441 which is closed upon an opening completion of the door 200 and opened upon a closing completion of the door 200, a door closing completion switch 442 which is closed upon the closing completion of the door 200 and opened upon the opening completion of the door 200, and an operation signal switch 443 receiving an opening/closing signal of the door 200 which is generated from one-touch switch provided to the driver seat of the vehicle to thereby selectively connect a circuit.

In addition, the door controller 400 includes a constant-voltage power supply switching regulator 450 converting power applied to the door controller 400 and a storage module 460 storing a power down program stopping the door controller 400.

By using the switching regulator 450 and the power down program, a dark current is minimized which leaks and disappears when the swing door is not operated or the vehicle is parked.

It is possible to form a circuit suppressing an amount of current consumption in the door controller 400 by using the switching regulator 450 in the case in which the vehicle is parked for a long time.

Since the dark current is minimized, a power margin may occur and a convenience device such as a wireless opening/closing device, or the like using the power margin may be additionally installed.

The door controller 400 controls the door opening/closing motor 300 in a pulse width modulation (PWM) control by an input pulse. In this case, the door controller 400 controls the door opening/closing motor 300 so that a closing speed of the door 200 is slower than the related art, thereby degrading noise generated upon the closing of the door 200 in comparison with the related art. In addition, the door controller 400 controls a torque of the door opening/closing motor 300 so that the door 200 is not rotated at a faster speed than a design speed when the swing door is operated at a slope of 20%.

In addition, when the vehicle is on an inclined road, the door controller 400 controls an operation of the door opening/closing motor 300 in an inclined road condition so that the door 200 may be smoothly opened or closed. More specifically, the door controller 400 according to the exemplary embodiment of the present invention controls an operation mode and a speed of the door opening/closing motor 300 by a combination of PWM obtained by dividing a timer clock pulse inside a motor control unit (MCU) using a C-program design, an A/D obtained by dividing a motor servo pulse and a current value, and a program function design for each state mode.

The state mode of the door controller 400 includes a power door open mode, a power door close mode, and a safety device mode.

The power door open mode is a mode in which the door controller 400 generates a buzzer sound and operates the door opening/closing motor 300 and the lock releasing motor 500 at the same time by a signal instruction generated according to one-touch switch manipulation of the driver to thereby release the latch 210, and then controls a speed of the door opening/closing motor 300 depending on a degree of inclination of a ground on which the vehicle is parked.

The power door close mode is a mode in which the door controller 400 generates the buzzer sound by a signal instruction generated according to one-touch switch manipulation of the driver and controls the speed of the door opening/closing motor 300 depending on a degree of inclination of a ground on which the vehicle is parked.

The safety device mode is a mode in which when an object got caught in the door 200 or it is sensed that the object is present in the boarding gate, upon the opening or closing of the door 200, the door controller 400 controls the buzzer and other alarm units.

The door controller 400 generates an obstacle sensing warning buzzer sound when the object got caught in the door 200 during the closing of the door 200, and stops the warning buzzer sound generation after opening the door 200.

The door controller 400 stops the closing of the door 200 when it is read by a photograph that the object is present in the boarding gate during the closing of the door, generates a warning buzzer sound, a sense releasing intermittence sound, or a mode switching continuous sound, and stops the generation of the buzzer sound, the intermittence sound, or the continuous sound after a predetermined time laps or by a signal.

In the electrical swing door according to various embodiments of the present invention, a swing door open or close instructing switch mounted on the driver seat is a one-touch switch. As one-touch switch, a push button switch or a momentary toggle switch may be used, and one-touch operating logic is applied.

The electrical swing door according to various embodiments of the present invention having the configuration as described above is operated so that the door controller 400 receives an instruction signal opening or closing the door 200 by one-touch switch manipulation of the driver, the door controller 400 then the door opening/closing motor 300 and operates the lock releasing motor 500 at the same time to thereby release the latch 210, driving force of the door opening/closing motor 300 is transferred to the main arm 100 to rotate the main arm 100, thereby opening or closing the boarding gate by the door 200 attached to the main arm 100.

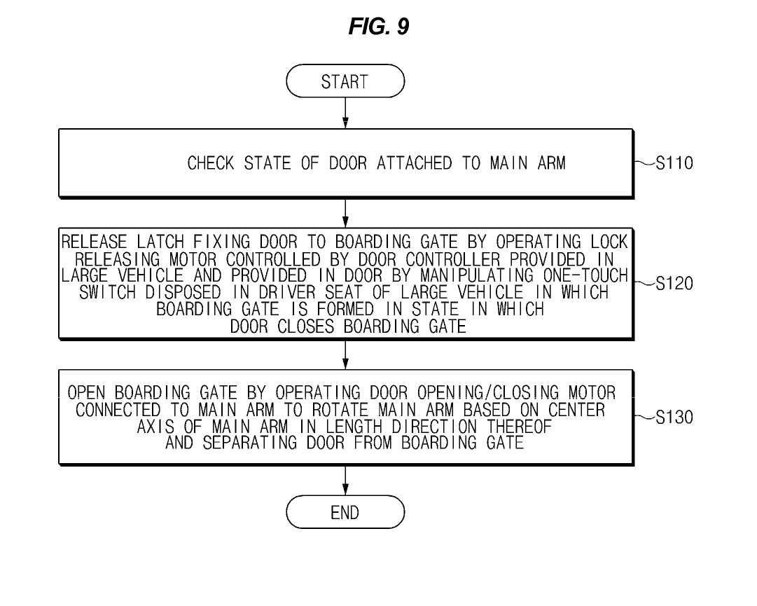

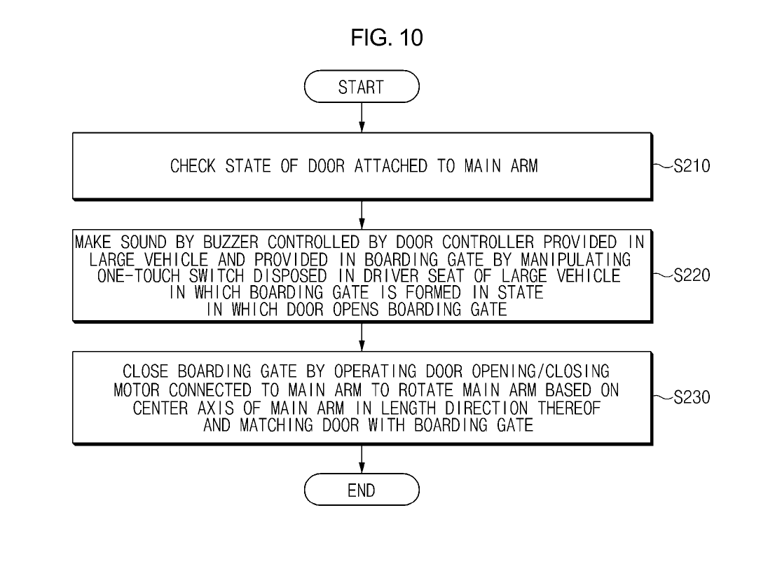

A detailed description thereof will be provided below. FIG. 9 illustrates a flowchart of an opening method of an electrical swing door according to various embodiments of the present invention and FIG. 10 illustrates a flowchart of a closing method of the electrical swing door according to the present invention.

As illustrated in FIG. 9, the opening method of the electrical swing door according to various embodiment of the present invention includes a door state checking step (S110) of checking a state of a door 200 attached to a main arm 100 pivotably disposed on a vehicle body, a latch releasing step (S120) of releasing a latch 210 fixing the door 200 to a boarding gate by operating a lock releasing motor 500 controlled by a door controller provided in a vehicle and provided in the door 200 by manipulating one-touch switch disposed in a driver seat of the vehicle in which the boarding gate is formed in a state in which the door 200 closes the boarding gate, and an opening step (S130) of opening the boarding gate by operating a door opening/closing motor 300 connected to the main arm 100 to rotate the main arm 100 based on a center axis of the main arm 100 in a length direction thereof and separating the door 200 from the boarding gate.

In the door state checking step (S110), positions of the door open completion switch 441 and the door close completion switch 442 provided in the door controller 400 are checked to check whether the door 200 is in a closed state.

The latch releasing step (S120) includes a step of checking whether or not a switch is failure, in which a chattering state of a one-touch switch is checked, a switch manipulating step of checking a manipulation of one-touch switch, a notification step of making a sound by a buzzer provided in the boarding gate; and a releasing step of operating the lock releasing motor 500.

In the opening step (S130), a rotation speed of the door opening/closing motor 300 is controlled by a speed controlling unit 420 provided in the door controller 400.

The speed controlling unit 420 controls the number of revolutions of the door opening/closing motor 300 in pulse width modulation (PWM) depending on a position of the door close completion switch 442 provided in the door controller and controls the number of revolutions of the door opening/closing motor 300 in decelerated PWM depending on a position of the door 200.

The opening step (S130) is stopped when one-touch switch is again manipulated, or it is checked that the door 200 is fully opened, or the door opening/closing motor 300 is overloaded.

As illustrated in FIG. 10, the closing method of the electrical swing door according to various embodiments of the present invention includes a door state checking step (S210) of checking a state of a door 200 attached to a main arm 100 pivotably disposed on a vehicle body, a closing initial step (S220) of making a sound by a buzzer controlled by a door controller provided in a vehicle and provided in a boarding gate by manipulating one-touch switch disposed in a driver seat of the vehicle in which the boarding gate is formed in a state in which the door 200 opens the boarding gate, and a closing step (S230) of closing the boarding gate by operating a door opening/closing motor 300 connected to the main arm 100 to rotate the main arm 100 based on a center axis of the main arm 100 in a length direction thereof and matching the door 200 with the boarding gate.

In the door state checking step (S210), positions of the door open completion switch 441 and the door close completion switch 442 provided in the door controller 400 are checked to check whether the door 200 is in a closed state.

The closing step (S230) is stopped when one-touch switch is again manipulated, or it is checked that the door 200 is fully closed, or the door opening/closing motor 300 is overloaded.

The closing step (S230) includes an operation stopping step of stopping an operation of the door opening/closing motor 300 when a photo sensor 431 provided in the boarding gate senses an object in the course of closing the door 200, and a reverse operating step of reversely rotating the door opening/closing motor 300 when the object got caught between the door 200 and the boarding gate in the course of closing the door 200 to thereby separate the door 200 from the boarding gate.

In the closing step (S230), a rotation speed of the door opening/closing motor 300 is controlled by the speed controlling unit 420 provided in the door controller 400.

The speed controlling unit 420 controls the number of revolutions of the door opening/closing motor 300 in slow start PWM so that the rotation speed of the door opening/closing motor 300 is minimized at the time of starting the operation of the door opening/closing motor 300. In addition, the speed controlling unit 420 controls the number of revolutions of the door opening/closing motor 300 in decelerated PWM depending on a position of the door 200.

Before the closing initial step (S220), the latch releasing step may be performed at the time of operating the closing releasing the latch 210. The latch releasing step at the time of operating the closing includes a step of checking whether or not a switch is failure, in which a chattering state of one-touch switch is checked, a switch manipulating step of checking a manipulation of one-touch switch, and a notification step in which a buzzer provided in the boarding gate makes a sound.

As described above, according to various embodiments of the present invention, the motor for releasing the latch is provided to the swing door, whereby quality degradation of the swing door that was generated due to the cable for releasing the latch according to the related art may be solved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An electrical swing door comprising:
a main arm configured to be pivotably disposed on a vehicle body and have a door opening or closing a boarding gate attached thereto;
a door opening/closing motor configured to apply rotational force to the main arm and to be provided to the vehicle body to adjust the opening/closing of the door; and
a lock releasing motor configured to release a latch fixing the door to the boarding gate.

2. The electrical swing door according to claim 1, wherein the lock releasing motor includes:
a bracket fixed to the door;
a motor mounted on the bracket;
a linkage connected to the latch through a center link provided in the door; and
a wire connected to a door controller controlling the door opening/closing motor and the lock releasing motor.

3. The electrical swing door according to claim 1, further comprising a door controller controlling the door opening/closing motor and the lock releasing motor,
wherein the door controller includes:
a release controlling device configured to control the lock releasing motor;
a speed controlling device configured to control the door opening/closing motor;
a safety device controlling apparatus configured to receive a signal of a photo sensor provided in the boarding gate; and
a switching unit configured to receive an opening/closing signal of the door.

4. The electrical swing door according to claim 3, wherein the release controlling device, the speed controlling device, the safety device controlling apparatus, and the switching unit are formed on a single board.

5. The electrical swing door according to claim 3, wherein the switching unit includes:
a door opening completion switch configured to be closed upon an opening completion of the door and opened upon a closing completion of the door;
a door closing completion switch configured to be closed upon the closing completion of the door and opened upon the opening completion of the door; and
an operation signal switch configured to be operated by receiving the opening/closing signal of the door which is generated from a one-touch switch configured to be provided to a driver seat of a vehicle.

6. The electrical swing door according to claim 3, wherein the door controller includes:
a constant-voltage power supply switching regulator configured to convert power applied to the door controller; and
a storage module configured to store a power down program stopping the door controller.

7. The electrical swing door according to claim 1, wherein the boarding gate includes a buzzer making a sound at a time of the opening/closing of the door.

8. The electrical swing door according to claim 3, wherein the door opening/closing motor is attached to the door controller and the door opening/closing motor includes a link member connected to the main arm.

9. An opening method of an electrical swing door, the method comprising:
a door state checking step of checking a state of a door attached to a main arm pivotably disposed on a vehicle body;
a latch releasing step of releasing a latch fixing the door to a boarding gate by operating a lock releasing motor controlled by a door controller provided in a vehicle and provided in the door by manipulating a one-touch switch configured to be disposed in a driver seat of the vehicle in which the boarding gate is formed in a state in which the door closes the boarding gate; and
an opening step of opening the boarding gate by operating a door opening/closing motor connected to the main arm to rotate the main arm based on a center axis of the main arm in a length direction thereof and separating the door from the boarding gate.

10. The method according to claim 9, wherein the latch releasing step includes:
a step of checking whether or not a switch fails, in which a chattering state of one-touch switch is checked;
a switch manipulating step of checking a manipulation of the one-touch switch;
a notification step of making a sound by a buzzer provided in the boarding gate; and
a releasing step of operating the lock releasing motor.

11. The method according to claim 9, wherein the opening step is stopped in the case in which:
the one-touch switch is again manipulated,
it is checked that the door is fully opened, or
the door opening/closing motor is overloaded.

12. The method according to claim 9, wherein in the opening step, a rotation speed of the door opening/closing motor is controlled by a speed controlling device provided in the door controller,
the speed controlling device controls the number of revolutions of the door opening/closing motor in pulse width modulation (PWM) depending on a position of a door close completion switch provided in the door controller and controls a number of revolutions of the door opening/closing motor in decelerated PWM depending on a position of the door.

13. A closing method of an electrical swing door, the method comprising:
a door state checking step of checking a state of a door attached to a main arm pivotably disposed on a vehicle body;
a closing initial step of making a sound by a buzzer controlled by a door controller provided in a vehicle and provided in a boarding gate by manipulating a one-touch switch configured to be disposed in a driver seat of the vehicle in which the boarding gate is formed in a state in which the door opens the boarding gate; and
a closing step of closing the boarding gate by operating a door opening/closing motor connected to the main arm to rotate the main arm based on a center axis of the main arm in a length direction thereof and matching the door with the boarding gate.

14. The method according to claim 13, wherein the closing step is stopped in the case in which:
the one-touch switch is again manipulated,
it is checked that the door is fully closed, or
the door opening/closing motor is overloaded.

15. The method according to claim 13, wherein the closing step includes:
an operation stopping step of stopping an operation of the door opening/closing motor when a photo sensor provided in the boarding gate senses an object in a course of closing the door; and
a reverse operating step of reversely rotating the door opening/closing motor when the object gets caught between the door and the boarding gate in the course of closing the door to thereby separate the door from the boarding gate.

16. The method according to claim 13, wherein in the closing step, a rotation speed of the door opening/closing motor is controlled by a speed controlling device provided in the door controller, and
the speed controlling device controls the number of revolutions of the door opening/closing motor in slow start PWM so that the rotation speed of the door opening/closing motor is minimized at the time of starting the operation of the door opening/closing motor, and controls the number of revolutions of the door opening/closing motor in decelerated PWM depending on a position of the door.
